(19) United States
(12) Patent Application Publication
(10) Pub. No.: US 2003/0176128 A1
(43) Pub. Date: Sep. 18, 2003

(54) Structurally reinforced panels

(75) Inventors: Michael J. Czaplicki, Rochester, MI (US); Christopher Hable, Romeo, MI (US)

Correspondence Address: Scott A. Chapple, Dobrusin & Thennisch PC, Suite 311, 401 South Old Woodward Avenue, Birmingham, MI, 48009, US

(73) Assignee: L&L Products, Inc.

(21) Appl. No.: 10/098,952

(22) Filed: Mar. 15, 2002

(51) Int. Cl. B32B 3/06; B32B 27/38; B32B 17/02; B32B 17/04; B32B 27/04; B32B 27/12; B32B 15/08

(52) U.S. Cl. 442/175; 442/180; 428/297.4; 428/300.7; 428/301.1

(57) ABSTRACT

A structurally reinforced panel and a method of forming the panel are disclosed. The reinforced panel includes a panel portion, a reinforcement material and a buffer material disposed therebetween.

### FIELD OF THE INVENTION

The present invention relates generally to a structurally reinforced panel of an automotive vehicle or other article of manufacture, and more particularly to a panel structurally reinforced with a reinforcement material wherein a buffer material is disposed between the reinforcement material and the panel.

### BACKGROUND OF THE INVENTION

For many years the transportation industry has been concerned with designing structural members and materials that do not add significantly to the weight of a vehicle. At the same time, automotive applications require structural materials capable of providing reinforcement to targeted portions of the vehicle such as vehicle panels. It is known to apply a layer of reinforcement material to panels of automotive vehicles for structurally reinforcing the panels. However, reinforcement materials that provide desired levels of reinforcement may also have a tendency to at least partially deform the panels to which the materials are applied (such deformation sometimes being referred to as read-through). Thus, there is a need to provide materials, techniques and the like, which assist in minimizing such deformation while still maintaining a desired amount of reinforcement.

### SUMMARY OF THE INVENTION

The present invention satisfies one or more of these needs by providing a structurally reinforced panel and a method of manufacturing the same.

Accordingly, the present invention provides a structurally reinforced panel that includes a reinforcement material, a panel portion and a buffer material disposed therebetween. The reinforcement material is preferably at least partially composed of a matrix material, which is expandable or otherwise activatible when exposed to a stimulus such as heat, chemical exposure or otherwise. The matrix material is also preferably curable to harden and provide structural reinforcement to the panel portion. The buffer material is a compliant material, which provides cushion, compliance, stress relief or a combination thereof between the panel portion and the matrix material for absorbing one or more stresses that the matrix material would otherwise apply to the panel portion during activation or curing of the matrix material. The buffer material preferably includes at least one elastomer and is preferably curable to adhere to a surface of the panel portion. Optionally, the reinforcement material may also include a backing material for added structural integrity.

The present invention also provides a method of forming a structurally reinforced panel. The method includes a first step of providing a panel portion of the automotive vehicle. In another step, a reinforcement material is provided. In yet another step, a buffer material is applied to the panel portion, the reinforcement material or both. Thereafter, the reinforcement material is applied over at least part of a surface of the panel portion such that at least a portion of the buffer material is disposed between the reinforcement material and the panel portion. Preferably, for forming the reinforced panel, at least a portion of the reinforcement material, the buffer material or both are activated and cured.

### BRIEF DESCRIPTION OF THE DRAWINGS

The features and inventive aspects of the present invention will become more apparent upon reading the following detailed description, claims and drawings, of which the following is a brief description:

FIG. 1 is a sectional view of a panel structurally reinforced with a reinforcement material wherein a buffer material is disposed between the panel and the reinforcement material.

### DETAILED DESCRIPTION OF THE INVENTION

The invention relates to a structurally reinforced panel of an article, such as an automotive vehicle, a household or industrial appliance, furniture, storage containers or the like, and to a method of forming the panel. More particularly, the present invention relates to a reinforced panel of an automotive vehicle that includes a panel portion, a layer of reinforcement material applied (e.g., attached or otherwise bonded) to at least part of a surface of the panel portion and a buffer material positioned (e.g., applied or laminated) between the reinforcement material and the panel portion. Preferably, the reinforcement material of the panel portion provides a high strength to weight reinforcement material.

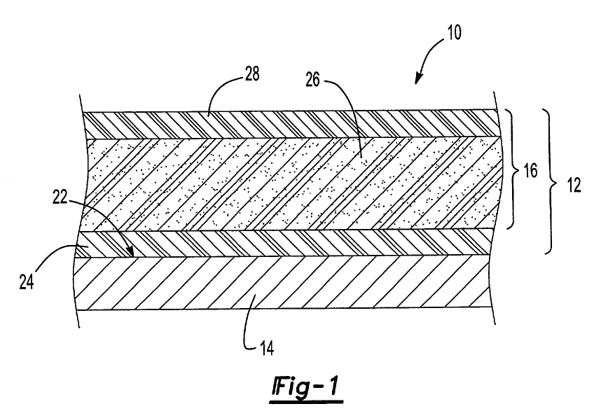

Referring to FIG. 1, there is illustrated an exemplary embodiment of a structurally reinforced panel 10. The panel 10 includes a layer 12 of composite material applied to a panel portion 14. In the embodiment shown, the composite material is composed of a layer 16 of reinforcement material, which is applied to at least a part of a surface 22 of the panel portion 14, and a layer 24 of buffer material disposed between the layer 16 of reinforcement material and the surface 22 of the panel portion 14.

As used herein, the term “panel portion 14” is broadly meant to encompass any component providing a surface 22 suitable for application of the layer 12 of composite material thereto. Preferably, the panel portion 14 is metal and includes a surface opposite the surface 22 to which the layer 12 of composite material is applied. For automotive applications, the panel portion 14 may be chosen from a variety of components of an automotive vehicle. Examples include components of a vehicle frame, components of a vehicle body or the like. In one highly preferred embodiment, the panel portion 14 is at least part of a body panel of an automotive vehicle wherein the body panel includes a surface that is visible from the outside of the vehicle and wherein that surface is opposite the surface 22 to which the layer 12 of composite material is applied. Examples of such panels include front and rear quarter panels, side panels, hood panels, trunk panels or the like.

Buffer Material

The layer 24 of buffer material is preferably a material that has elastomeric or compliant properties. The buffer material may include one or any combination of the following components: one or more polymer components (e.g., elastomers, plastomers, rubbers, plastics or the like), one or more fillers or additives and one or more curing agents or adhesives. Other components may be included in the buffer material as well such as component for imparting surface tack, magnetism or the like to the material. Moreover, the buffer material may be water-based, solvent-based, substantially solid or otherwise. Preferably, the components of the buffer material are chosen such that the buffer material is capable of viscoelastic recovery during and after installation of the layer 12 of composite material to the panel portion 14.

Typically the polymer components will include at least one elastomer. Exemplary elastomers include natural and synthetic isoprenes, propylenes, styrene butadiene copolymers, terpolymers of ethylene, isobutene isoprene polymers, butadiene copolymers, nitrile butadiene copolymers, chlorosulphonated polyethylenes, polysiloxanes, polyesters, polyisobutylenes fluorinated hydrocarbon or the like. In one preferred embodiment, the polymer component is at least partially composed of an acrylic elastomer such as an acrylonitrile butadiene terpolymer. In another preferred embodiment the polymer component is at least partially composed of a styrene butadiene rubber. In highly preferred embodiments, the elastomer of the buffer material is carboxylated for assisting the buffer material in adhering to adjacent materials, reacting with adjacent materials or both.

Elastomers of the buffer material or the buffer material itself preferably have a relatively low glass transition temperature (T_{g}) for maintaining the buffer material in a compliant state during use. In preferred embodiments, the buffer material has a glass transition temperature that is less than substantially any temperatures to which the buffer material may be exposed while in its intended environment of use (e.g., in an automotive vehicle). As examples, the glass transition temperature may be below about 0° C., more preferably below about −20° C., still more preferably below about −40° C. and most preferably below about −50° C.

A variety of other materials may also be suitable for, and may be included in the polymer components of the buffer material. As an example, one or more epoxy-based materials such as epoxy resins may be included in the buffer material. Such epoxy-based materials may assist in cross-linking of the buffer material if such cross-linking is desired. Moreover, such epoxy materials may also assist in increasing the ability of the buffer material to adhere to adjacent materials. One exemplary family of resins from which a suitable epoxy may be chosen are bisphenol A epoxies. Exemplary commercially available epoxies are sold under the tradenames DER331 and DER661 from The Dow Chemical Corporation and under the tradename EPON from Resolution Performance Products. It shall be recognized by the skilled artisan that several other materials may also be included in the polymer components of the buffer material depending on desired properties and characteristics of the buffer material.

One or more curing agents may also be added to the buffer material. Amounts of curing agents can vary widely within the buffer material depending upon the desired amount of elasticity, strength, toughness or the like of the buffer material. Preferably, the curing agents assist the buffer material to cure by crosslinking of the polymers, elastomers or both. Additionally, it is preferable for the curing agents to assist in thermosetting the buffer material.

Useful classes of curing agents are materials selected from aliphatic or aromatic amines or their respective adducts, amidoamines, polyamides, cycloaliphatic amines (e.g., anhydrides, polycarboxylic polyesters, isocyanates, (phenol-based resins such as phenol or cresol novolak resins, copolymers such as those of phenol terpene, polyvinyl phenol, or bisphenol-A formaldehyde copolymers) bishydroxyphenyl alkanes or the like), modified ureas, modified imidazoles or mixtures thereof. Particular preferred curing agents include modified and unmodified polyamines such as triethylenetetramine, diethylenetriamine tetraethylenepentamine, cyanoguanidine and the like. In one highly preferred embodiment, the curing agent at least partially includes dicyandiamide.

Optionally, the buffer material may include one or more fillers or other additives, including but not limited to, particulated materials (e.g., powder), beads, microspheres, or the like. Examples of fillers and additives include silica, diatomaceous earth, glass, clay, talc, pigments, colorants, glass beads or bubbles, glass, carbon ceramic fibers, antioxidants, ferrite materials and the like. Preferably, a filler is generally non-reactive with the other components present in the buffer material. Functionally, fillers such as thickeners or thinners may be used to increase or decrease the density, viscosity or the like of the buffer material. In one preferred embodiment, magnetic fillers are used to increase adhesion between the buffer material and adjacent metal panels. When employed, the fillers and additives in the buffer material can range from about 0.01% by weight up to about 20% by weight and even up to about 70% of the buffer material.

In one preferred embodiment, the buffer material is a curable material that is substantially composed of an elastomer and an epoxy resin that includes a curing agent. In the embodiment, the elastomer component is typically present in the buffer material in amounts ranging from about 20% to about 99% by weight, preferably in amounts ranging from about 40% to about 90% by weight, more preferably in amounts ranging from about 60% to about 80% by weight and most preferably in amounts ranging from about 65% to about 75% by weight (e.g., about 70% by weight). The epoxy resin is preferably present in the buffer material in amounts ranging from about 1% to about 50% by weight, more preferably in amounts ranging from about 15% to about 40% by weight, still more preferably in amounts ranging from about 20% to about 30% by weight (e.g., about 28% by weight). Additionally, the curing agent is preferably present in the buffer material in amounts ranging from about 0.01% to about 10% by weight, more preferably from about 0.1% to about 5% by weight, still more preferably from about 1% to about 3% (e.g., about 2% by weight).

In another preferred embodiment, the buffer material is substantially entirely composed of (e.g., from about 90% to about 100% by weight) an elastomeric material. In the embodiment, the elastomeric material is preferably a thermoplastic with a relatively high molecular weight or a high degree of polymerization or both. Exemplary thermoplastics include polyisobutenes, polyisobutylenes, copolymers of ethylene with acrylate or vinyl acetate or other like polymers. The elastomeric material in this preferred embodiment may have as few as six (6) monomeric repeat units. Preferably, however, the elastomeric material includes at least one hundred (100) repeat units, more preferably at least about one thousand (1000) monomeric repeat units, still more preferably at least about ten thousand (10) or more monomeric repeat units. Exemplary preferred molecular weights are those high enough to achieve a viscosity of about 100,000 centipoise, more preferably about 500,000 centipoise and most preferably about 1,000,000 centipoise.

Reinforcement Material

The layer 16 of reinforcement material may be configured in a variety of shapes, designs, or thicknesses corresponding to the dimensions of the selected panel portion 14 of the vehicle or as otherwise desired. The layer 16 of reinforcement material may be composed of one substantially homogeneous material or layer or multiple different materials or layers. Preferably, at least a portion of the reinforcement material is expandable, curable or both.

In one preferred embodiment, and referring to FIG. 1, the layer 16 of reinforcement material includes at least a layer 26 of matrix material and a layer 28 of backing material. The backing material may be chosen from a variety of materials. For example, and without limitation, the backing material may be formed of metal foils, metal sheets, metal screens or the like. As alternative examples, the backing material may be formed of polymeric (e.g., thermoplastic) films, sheets or mesh. In still other alternative embodiments, the backing material may be formed of cellulose fiber material such as impregnated or non-impregnated paper, wood or the like.

For certain applications, particularly automotive applications, it may be preferable for the backing material to be a filament, fibrous or fabric material. In such embodiments, the backing material may be composed of, for example, woven or unwoven strands, fibers, filaments or the like of cotton, fiberglass, nylon, carbon, aramid or other materials. In one highly preferred embodiment, the backing material is a fabric formed of fiberglass strands such as a weave or roving of fiberglass strands. The skilled artisan will recognize that, although preferred materials have been disclosed herein, various alternative materials may be chosen for the backing material depending upon the needed or desired properties or functionality for a particular application.

The matrix material is preferably selected so as to be activatible under a desired condition to soften (e.g, melt), expand, foam or otherwise change states such that the matrix material can wet, and preferably bond to adjacent surfaces (e.g., the surfaces provided by the layer 28 of backing material, the panel portion 14 or a combination thereof). In one embodiment, the matrix material is also selected to cure during or after activation and, upon or after cure, form a relatively low density, low weight material with high strength characteristics such as high stiffness for imparting structural rigidity to a reinforced region of the panel portion 14. In a preferred embodiment, the matrix material has a post-cure glass transition temperature that is greater than any temperatures to which the matrix material may be exposed while in its intended environment of use (e.g., in an automotive vehicle). Exemplary glass transition temperatures may be greater than about 50 degrees Celcius and more preferably greater than about 70 degrees Celsius. Other desired characteristics of the matrix material might include good adhesion retention and degradation resistance particularly in the presence of corrosive or high humidity environments.

A number of structurally reinforcing matrix materials may be used to form the layer 26. The matrix material may be a thermoplastic, a thermoset or a blend thereof. According to one embodiment, the matrix material is as an epoxy-based material, an ethylene-based polymer, or a mixture thereof, which when compounded with appropriate ingredients (typically a blowing agent, a curing agent, and perhaps a filler), typically expands and cures in a reliable and predictable manner upon the application of heat or another activation stimulus.

Thus, according to one embodiment, the matrix material is a heat-activated, epoxy-based resin having foamable characteristics upon activation through the use of heat typically encountered in an e-coat or other paint oven operation. Preferably, the epoxy matrix material is such that upon being heated, it structurally bonds to adjacent surfaces. From a chemical standpoint for a thermally-activated material, such matrix material is usually initially processed as a thermoplastic material before curing. After curing, the matrix material typically becomes a thermoset material that is fixed and incapable of any substantial flowing. Examples of preferred formulations that are commercially available include those available from L&L Products, Inc. of Romeo, Mich., under the designations L-5204, L-5206, L-5207, L-5208, L-5209, L-5214, L-5222 and L-8000.

The layer 26 of matrix material may be formed using a variety of processing techniques, machines and the like. Possible processing techniques for the preferred materials include injection molding, blow molding, thermoforming, extrusion with a single or twin screw extruder or extrusion with a mini-applicator extruder. In a preferred embodiment, the layer 10 of matrix material is extruded using a twin-screw extruder and with the resulting layer 26 having a substantially continuous thickness or a variable thickness.

Though preferred matrix materials are disclosed other suitable art disclosed matrix material may be used in conjunction with the present invention. The choice of the matrix material used will be dictated by performance requirements and economics of the specific application and requirements. Examples of other possible matrix materials include, but are not limited to, polyolefin materials, copolymers and terpolymers with at one monomer type an alpha-olefin, phenol/formaldehyde materials, phenoxy material, polyurethane materials with high glass transition temperatures (including polyureas), and mixtures or composites (optionally including solid or porous metals). See also, U.S. Pat. Nos. 5,766,719; 5,755,486; 5,575,526; 5,932,680 (incorporated herein by reference).

Generally speaking, exemplary automotive vehicle applications may utilize technology and processes such as those disclosed in U.S. Pat. Nos. 4,922,596, 4,978,562, 5,124,186 and 5,884,960 and commonly owned, co pending U.S. application Ser. No. 09/502,686 filed Feb. 11, 2000, Ser. No. 09/524,961 filed Mar. 14, 2000, No. 60/223,667 filed Aug. 7, 2000, No. 60/225,126 filed Aug. 14, 2000, Ser. No. 09/676,443 filed Sep. 29, 2000, Ser. No. 09/676,335 filed Sep. 29, 2000, Ser. No. 09/676,725 filed Sep. 29, 2000, and particularly, Ser. No. 09/459,756 filed Dec. 10, 1999, all of which are expressly incorporated by reference.

In applications where the matrix material is a heat activated material, such as when a thermally melting, expanding, or foaming material is employed, an important consideration involved with the selection and formulation of the material can be the temperature at which the material activates, cures or both. In most applications, it is undesirable for the material to activate at room temperature or the ambient temperature in a production or assembly environment. For automotive applications, it may be desirable for the matrix material to activate at higher processing temperatures, such as those encountered in an automobile assembly plant, when the matrix material is processed along with the automobile components at elevated temperatures. Exemplary temperatures encountered in an automobile assembly body shop oven may be in the range of 148.89° C. to 204.44° C. (300° F. to 400° F.), and paint shop oven temps are commonly about 93.33° C. (215° F.) or higher. If needed, for foaming or expanding type matrix materials, various blowing agent activators can be incorporated into the composition to cause expansion at different temperatures outside the above ranges.

Although many matrix materials may be heat activated, other matrix materials that are activated by another stimuli and are capable of bonding also can be used. Without limitation, such matrix material may be activated by alternative stimuli such as, pressure, chemicals, or by other ambient conditions.

Manufacture

Generally speaking, the composite material 12 is applied to the panel portion 14 by applying the layer 16 of reinforcement material to a surface of the panel portion 14 in a manner that disposes the layer 24 of buffer material between the reinforcement material and the panel portion 14. This may be accomplished by applying the buffer material to the panel portion 14, the reinforcement material or both followed by application of the layer 16 of reinforcement material to the panel portion 14. The buffer material may be applied to the reinforcement material or the panel portion using various techniques such as spraying, coating (e.g., roll coating), lamination, co-extrusion or the like.

In one preferred embodiment, the layer 28 of backing material is positioned (e.g., laminated) as desired upon a first side of the layer 26 of matrix material and the layer 24 of buffer material is positioned (e.g., laminated) as desired upon a second side of the layer 26 of matrix material. As shown, the first and second sides of the matrix material may be generally opposite each other, however, such a configuration is not necessarily required. Preferably, the layer 26 of matrix material, the layer 24 of buffer material or both are at least slightly tacky prior to their activation, cure or both such that the layer 28 of backing material and the layer 24 of buffer material can adhere to the layer 26 of matrix material at least until the layer 26 of matrix material is activated.

A pressure or force is typically applied to the layer 28 of backing material, the layer 24 of buffer material, the layer 16 of reinforcement material or a combination thereof, urging the various layers 16, 24, 26 and 28 into intimate contact with each other. In one preferred embodiment, the layer 16 of reinforcement material is formed by continuously extruding the layer 26 of matrix material while continuously laminating the layer 28 of backing material thereto. In this embodiment, the layer 24 of buffer material is preferably applied (e.g., co-extruded or sprayed on) successively or simultaneously with the layer 28 of backing material. Release paper may be applied (e.g., laminated) upon the layer 24 of buffer material before or after applying the buffer material to the layer 26 of matrix material, but preferably while the layer 24 of buffer material is still in a pre-activated tacky state. Thereafter, the backing material, the matrix material, the buffer material and the release paper or a combination thereof may be pressed into intimate contact with each other for forming the layer 12 of composite material. Such contact may be achieved using one or more rollers or other alternative mechanisms. Preferably, a side of the layer 24 of buffer material covered by the release paper remains protected and at least partially tacky such that the release paper may be removed and the layer 24 of buffer material together with the layer 16 of reinforcement material may be applied (e.g., adhered and/or laminated to the panel portion 14.

The reinforcement material and the buffer material may be applied generally as desired to the panel portion 14. Preferably, however, the reinforcement material and the buffer material are applied to panel portions to reduce deformation in selected areas. For targeting certain areas or for properly fitting the reinforcement material and the buffer material upon a panel portion, preformed patterns may be employed such as those made by molding, lay-up, or by extruding a sheet (having a flat or contoured surface) of reinforcement material, buffer material or both with or without release paper and then die cutting the sheet in accordance with a predetermined configuration.

Preferably, the layers 16, 24 of reinforcement and buffer material are applied to the panel portion 14 in a solid or semi-solid state. However, the layers 16, 24 may be applied to the surface 22 of the panel portion 14 in a fluid state using commonly known manufacturing techniques. The buffer material, the matrix material or both may be heated to a temperature that permits those materials to flow slightly to aid in wetting the surface 22 of the panel portion 14. Alternatively, the layer 16 may also be applied by heat bonding/thermoforming or by co-extrusion.

For forming the reinforced panel 10 of FIG. 1, the buffer material, the reinforcement material or both may each be activated and/or cured. Activation may be induced by a variety of stimuli such as moisture, chemicals, heat or the like and curing may also be induced by a variety of stimuli such as time, cooling or the like.

The layer 16 of reinforcement material preferably expands upon activation and hardens upon curing such that the layer 16 can provide added structural integrity to the panel portion 14. The layer 24 of buffer material may be induced to flow slightly upon activation to wet the surface 22 of the panel portion 14 the layer 16 of reinforcement material or both. Preferably, the layer 24 of buffer material adheres, and/or reactively bonds to both the surface 22 of the panel portion 14 and to the layer 16 reinforcement material upon curing. It is contemplated that in addition to the buffer material, the reinforcement material may also wet and adhere to the surface 22 of the panel portion 14.

In one embodiment, the layer 26 of matrix material, the layer 24 of buffer material or both are activated during an automotive bake cycle. In such an instance, it is preferable that the layer 24 of buffer material maintains a substantially high viscosity during the bake cycle such that the layer 24 substantially maintains its location between the layer 16 of reinforcement material and the panel portion 14.

Advantageously, for buffer materials with curing agents, curing of the buffer material may assist in adhering the buffer material to adjacent layers. Additionally, in certain embodiments, reactivity between the buffer material and the panel portion 14, the reinforcement material or both may occur for further increasing such adhesion. Notably, however, use of relatively high molecular weight or highly polymerized materials may allow the buffer material to perform functionally without having to cure and therefore substantially without any curing agent in the buffer material.

In the preferred embodiment wherein the layer 16 of reinforcement material is comprised of a layer 26 of matrix material and a layer 28 of backing material, the layer 26 of matrix material, upon activation thereof, preferably wets the layer 28 of backing material to promote integration of the backing material with the matrix material. In one embodiment, the wetting of the backing material can be advantageously enhanced by foaming or bubbling of the matrix material, which can enhance the integration of the backing material into the matrix material. Preferably, the integration of the backing material with the matrix material increases the strength of the layer 16 of reinforcement material such that the reinforcement material has a strength greater than the sum of the strength of the matrix material and the backing material taken individually.

Advantageously, the buffer material is compliant with respect to the reinforcement material during activation, cure or both of the reinforcement material. Such compliance allows the reinforcement material to expand, contract or both while the buffer material absorbs stress that might otherwise be exerted upon the panel portion 14. In this manner, the buffer material assists in minimizing any deformation of the panel portion 14 that might otherwise be caused by the expansion or contraction of the reinforcement material. As an additional advantage, use of the buffer material disclosed herein only minimally lessens or does not lessen the reinforcement ability of the reinforcement material.

It is contemplated that the layer 24 of buffer material may be configured to substantially cure after the layer 16 of reinforcement material thereby allowing the layer 16 of reinforcement material to substantially harden prior to cure of the buffer material. Advantageously, by curing the buffer layer after curing the reinforcement layer, the buffer layer may offer greater compliance and stress absorption. For delaying cure of the buffer material, an encapsulated curing agent may be used.

It is further contemplated within the present invention that the layer 16 of reinforcement material may be provided as a combination of a matrix material and a fiberglass woven roving, which are disclosed in commonly owned U.S. patent application Ser. No. 09/939,152, also titled “Structurally Reinforced Panels” and fully incorporated herein by reference for all purposes. Moreover, it is contemplated that additional strength exhibited by the use of the matrix material and fiberglass woven roving may more than offset any loss in strength due to the use of the buffer material of the present invention.

In the embodiment disclosed, the layer 16 of reinforcement material and the layer 24 of buffer material may be utilized in conjunction with panel portions 14 of an automotive vehicle, which may be included in, without limitation, front and rear quarter panels, door panels, floor pans, floor panels, roof panels, hood panels, trunk panels and the like as well as other portions of an automotive vehicle which may be adjacent to the interior of exterior of the vehicle to form a reinforced panel 10.

The preferred embodiment of the present invention has been disclosed. A person of ordinary skill in the art would realize however, that certain modifications would come within the teachings of this invention. Therefore, the following claims should be studied to determine the true scope and content of the invention.

What is claimed is:

1. A structurally reinforced panel for an automotive vehicle, comprising:
(a) a metal panel portion;
(b) a reinforcement material that includes:
i) a matrix material selected from an epoxy-based material, an ethylene-based polymer, or a mixture thereof, the matrix material being layered upon panel portion; and
ii) a backing material disposed on the matrix material, the backing material being a fabric; and
(c) a buffer material disposed between the metal panel and the matrix material, the buffer material including:
i) an elastomer.

2. A structurally reinforced panel as in claim 1, wherein the backing material is formed of fiberglass strands.

3. A structurally reinforced panel as in claim 2, wherein the backing material is a woven roving.

4. A structurally reinforced panel as in claim 1, wherein the elastomer is a styrene butadiene rubber.

5. A structurally reinforced panel as in claim 1, wherein the matrix material is epoxy-based.

6. A structurally reinforced panel as in claim 1, wherein the buffer material includes a curing agent.

7. A structurally reinforced panel as in claim 1 wherein the panel portion is part of a body panel of the automotive vehicle.

8. A structurally reinforced panel as in claim 7 wherein the second surface of the panel portion is visible from outside of the automotive vehicle.

9. A structurally reinforced panel as in claim 8 wherein the panel portion is part of a quarter panel, hood panel, or a trunk panel of the automotive vehicle.

10. A composite material for reinforcing a panel portion of an automotive vehicle, comprising:
a) a reinforcement material that includes:
i) a backing material that is a fabric formed at least partially of fiberglass strands; and
ii) an expandable epoxy-based matrix material supporting the backing material, said matrix material being thermally expandable in a temperature range of about 300° F. to 400° F.; and
b) a buffer material laminated to a side of the matrix material, the buffer material including at least one elastomer; and
c) a release layer laminated to a side of the buffer material for protecting the side of the buffer material prior to bonding the side of the buffer material to the panel.

11. A composite material as in claim 10, wherein the at least one elastomer is a styrene butadiene rubber.

12. A composite material as in claim 10, wherein the matrix material is epoxy-based.

13. A composite material as in claim 10 wherein the fiberglass strands are woven.

14. A composite material as in claim 10 wherein the buffer material includes a curing agent.

15. A composite material as in claim 10 wherein the buffer material includes at least 90% by weight of a thermoplastic with at least 100 monomeric repeat units.

16. A structurally reinforced panel for an automotive vehicle, comprising:
(a) a metal panel portion, which is part of a body panel of the automotive vehicle, the panel portion including a first surface opposing a second surface;
(b) a reinforcement material that includes:
i) a matrix material selected from an epoxy-based material, an ethylene-based polymer, or a mixture thereof, the matrix material being layered upon the first surface of the panel portion, the matrix material being expandable upon exposure to temperatures in the range about 300° F. to 400° F.; and
ii) a backing material disposed on the matrix material, the backing material being a fabric that is formed of fiberglass strands that are woven together; and
(c) a buffer material in contact with and adhered to the first surface of the panel portion and the matrix material, the buffer material disposed between the panel poriton and the matrix material, the buffer material including:
i) an elastomer selected from an isoprene, a butadiene copolymer or a combination thereof; and
wherein the matrix material is curable after expansion, the matrix material hardening upon curing to structurally reinforce the panel portion, the buffer material relieving stress between the matrix material and the panel portion upon curing of the matrix material thereby inhibiting deformation of the panel portion.

17. A structurally reinforced panel as in claim 16 wherein the second surface of the panel portion is visible from outside of the automotive vehicle.

18. A structurally reinforced panel as in claim 17 wherein the panel portion is part of a quarter panel, hood panel, or a trunk panel.

19. A structurally reinforced panel as in claim 16 wherein the buffer material includes a curing agent.

20. A composite material as in claim 16 wherein the buffer material includes at least 90% by weight of a thermoplastic with at least 100 monomeric repeat units.
